(19) United States
(12) Patent Application Publication
(10) Pub. No.: US 2015/0344061 A1
(43) Pub. Date: Dec. 3, 2015

(54) STEERING AND METHOD OF MANUFACTURING THE SAME

(71) Applicant: NIHON PLAST CO., LTD., Shizuoka (JP)

(72) Inventors: Nobutaka UEMATSU, Shizuoka (JP); Kazushige ONISHI, Shizuoka (JP); Ken SASAKI, Shizuoka (JP)

(21) Appl. No.: 14/722,635

(22) Filed: May 27, 2015

(30) Foreign Application Priority Data
May 30, 2014 (JP) 2014-112387

(51) Int. Cl. B62D 1/06; B29C 45/00; H05B 3/18; H05B 3/00; H05B 3/54

(52) U.S. Cl. CPC B62D 1/065; H05B 3/0014; H05B 3/54; H05B 3/18; B29C 45/0084; B29L 2031/3047

(57) ABSTRACT

A steering and a method of manufacturing the steering are disclosed. In the steering, a heater is used in which a heating wire is fixed to a surface of a porous sheet having a density equal to 30±5 kg/m³ and a number of cells equal to 8±2 cells/25 mm, as the heater to be fixed in the cover portion. The heater is would around a rim core metal and placed in a cavity. The cover portion that integrally covers the rim core metal and the heater is molded by closing a mold and injecting a synthetic resin material into a cavity.

### CROSS REFERENCE TO RELATED APPLICATION

This application is entitled to the benefit of Japanese Patent Application No. 2014-112387 filed on May 30, 2014, the disclosure of which including the specification, drawings and abstract is incorporated herein by reference in its entirety.

### TECHNICAL FIELD

The present invention relates to a steering including an operational grip portion having a heater embedded in a cover portion, and also relates to a method of manufacturing the steering.

### BACKGROUND ART

In recent years, electric vehicles (EVs), which involve less environmental burdens, and can be substituted for gasoline-engine vehicles, have become popular and have been adopted as an approach to conserve the global environment and to reduce the production of greenhouse gases. Such an electric vehicle includes a combination of a storage battery and a motor and basically needs to charge power from an external charger. For this reason, measures to reduce the consumption of battery power are required for the electric vehicles. Reducing the power consumption for heating (air conditioning), which requires a large amount of power consumption, is the most effective solution among the measures.

In this respect, adopting a technique to directly transmit the heat via a steering wheel to be directly held by a passenger (driver) has begun. As an example of the technique, a configuration in which a heating wire serving as a heating element is embedded in the steering wheel is known.

More specifically, a heater is incorporated in the steering wheel to heat the steering wheel during a period even a little after the engine starts, i.e., even when each engine part is not yet heated enough. This configuration makes it possible to reduce the use of heating and thus to reduce the power consumption while mitigating operational difficulty and/or discomfort caused by the cold steering wheel, when a driver starts driving an automobile that has been parked outside in winter, for example.

As an example of such a configuration, there is known a configuration in which a heater formed by interweaving heating wires in mesh, for example, is attached annularly to the inner surface of the skin portion using a double sided tape while the skin portion is wound around the outer circumference of a rim portion and fixed to the rim portion by a double sided tape attached along a width direction of the skin portion (see, e.g., Patent Literature (hereinafter, referred to as “PTL”) 1).

In addition, another configuration is known in which a planar heating element is disposed on a core metal of a steering wheel and a skin portion is wound around while covering the planar heating element (see, e.g., PTL 2).

### CITATION LIST

### Patent Literature

### PTL 1

Japanese Patent Application Laid-Open No. 2002-96737 (pages 4 and 5 and FIGS. 1 through 5)

### PTL 2

Japanese Patent Application Laid-Open No. 2004-58864 (page 4 and FIGS. 1 and 2)

### SUMMARY OF INVENTION

### Technical Problem

In the configuration disclosed in PTL 1, however, the heater needs to be attached to the skin portion in advance, which causes an increase in the number of manufacturing steps.

Meanwhile, in the configuration disclosed in PTL 2, the planar heating element disposed on the core metal needs to be fixed using an adhesive such as a double sided tape, which causes an increase in the number of manufacturing steps.

Thus, it is desired to reduce the number of manufacturing steps to further reduce the manufacturing costs.

The present invention takes the above mentioned points into consideration and aims to provide a steering that makes it possible to suppress the manufacturing costs and to surely fix a heater within a cover portion, and also aims to provide a method of manufacturing the steering.

### Solution to Problem

A steering according to a first aspect includes an operational grip portion, in which the operational grip portion includes: a grip-part core metal, a cover portion that is made of a synthetic resin and that covers the grip-part core metal, and a heater embedded in the cover portion, in which the heater includes: a porous sheet having a density equal to 30±5 kg/m³ and a number of cells equal to 8±2 cells/25 mm, the porous sheet being wound around the grip-part core metal and embedded in the grip portion, and a heating wire fixed to a surface of the porous sheet, embedded in the cover portion, and configured to generate heat by energization.

In the steering according to a second aspect, the heater is embedded at a depth equal to or greater than 0.5 mm from a surface of the cover portion of the steering according the first aspect.

A method of manufacturing a steering according to a third aspect includes an operational grip portion which includes: a grip-part core metal, a cover portion that is made of a synthetic resin and that covers the grip-part core metal, and a heater embedded in the cover portion, the method including: using a heater in which a heating wire is fixed to a porous sheet having a density equal to 30±5 kg/m³ and a number of cells equal to 8±2 cells/25 mm, and which serves as the heater to be embedded in the cover portion; opening a shaping mold, winding the heater around the grip-part core metal, and setting the wound heater in a cavity; and closing the shaping mold and injecting a synthetic resin material into the cavity to mold the cover portion by integrally covering the grip-part core metal and the heater with the synthetic resin.

In the method of manufacturing a steering according to a fourth aspect, the heater is wound around the grip-part core metal with the heating wire placed at an outer side position in the method of manufacturing a steering according to the third aspect.

### Advantageous Effects of Invention

With the steering according to the first aspect, the density and the number of cells of the porous sheet of the heater embedded in the cover portion are set to 30±5 kg/m³ and 8±2 cells/25 mm, respectively, and the cover portion is molded while the porous sheet to which the heating wire of the heater has been fixed is wound around the grip-part core metal. Thus, the porous sheet does not block the flow of fluid synthetic resin forming the cover portion, and the heater can be easily embedded in the cover portion simultaneously with molding of the cover portion. For this reason, the manufacturing costs can be reduced, and the pores of the porous sheet can be surely filled with the synthetic resin forming the cover portion. Accordingly, the heater can be surely fixed within the cover portion.

With the steering according to the second aspect, in addition to the effects obtained by the steering according to the first aspect, embedding the heater at a depth equal to or greater than 0.5 mm from the surface of the cover portion of the heater makes it possible to surely suppress the formation of irregularities on the surface of the cover portion due to the presence of the heating wire, and also to surely transmit the heat generated from the heating wire to the hands holding the grip portion.

With the method of manufacturing a steering according to the third aspect, the heater is used in which a heating wire is fixed to a porous sheet having a density equal to 30±5 kg/m³ and a number of cells equal to 8±2 cells/25 mm, and which serves as the heater to be embedded in the cover portion. In addition, the cover portion is molded while the heater is wound around the grip-part core metal. Thus, the porous sheet does not block the flow of fluid synthetic resin forming the cover portion. In addition, the heater can be easily embedded in the cover portion simultaneously with the molding of the cover portion. Thus, the manufacturing costs can be reduced, and the pores of the porous sheet can be surely filled with the synthetic resin forming the cover portion. Accordingly, the heater can be surely fixed within the cover portion.

With the method of manufacturing a steering according to the fourth aspect, in addition to the effects obtained by the method of manufacturing a steering according to the third aspect, the heater is wound around the grip-part core metal with the heating wire placed at an outer side position. Thus, the heating wire can be surely spaced from the grip-part core metal, and the heat generated by the heating wire can be transmitted to the hands holding the grip portion, rather than towards the grip-part core metal.

### BRIEF DESCRIPTION OF DRAWINGS

FIG. 1 is a perspective cross-sectional view of a part of a steering according to a first embodiment of the present invention;

FIG. 2 is a vertical cross-sectional view of a part of a grip portion of the steering;

FIG. 3 is a perspective view illustrating some steps of a method of manufacturing the steering;

FIG. 4 is a perspective view illustrating a step subsequent to the steps of the method of manufacturing the steering illustrated in FIG. 3;

FIG. 5A is a front view of a state where a heater is wound around a core metal according to the method of manufacturing the steering;

FIG. 5B is a cross-sectional view of the state where the heater is wound around the core metal according to the method of manufacturing the steering;

FIGS. 6A to 6D are cross-sectional views sequentially illustrating molding steps for a cover portion according to the method of manufacturing the steering;

FIGS. 7A to 7D are plan views sequentially illustrating molding steps for the cover portion according to the method of manufacturing the steering;

FIG. 8 is a front view of the steering;

FIG. 9 is a perspective cross-sectional view of a part of a steering according to a second embodiment of the present invention;

FIG. 10 is a cross-sectional view taken along line I-I of FIG. 9;

FIGS. 11A to 11D are explanatory views sequentially illustrating steps of manufacturing a heater according to a method of manufacturing the steering;

FIG. 12 is a cross-sectional view illustrating some steps of the method of manufacturing the steering;

FIG. 13 is a cross-sectional view illustrating some steps of a method of manufacturing a steering according to a third embodiment of the present invention;

FIG. 14 is a cross-sectional view illustrating a step subsequent to the steps of the method of manufacturing the steering illustrated in FIG. 13;

FIG. 15 is a cross-sectional view illustrating a step subsequent to the steps of the method of manufacturing the steering illustrated in FIG. 14;

FIG. 16 is a cross-sectional view illustrating a step subsequent to the steps of the method of manufacturing the steering illustrated in FIG. 15;

FIG. 17 is a plan view illustrating a part of an intermediate body manufactured by the step of the method of manufacturing the steering illustrated in FIG. 15;

FIG. 18 is a cross-sectional view illustrating a step subsequent to the method of manufacturing the steering illustrated in FIG. 16;

FIG. 19 is a cross-sectional view illustrating a step subsequent to the method of manufacturing the steering illustrated in FIG. 18;

FIG. 20 is a cross-sectional view illustrating some steps of a method of manufacturing a steering according to a fourth embodiment of the present invention;

FIG. 21 is a cross-sectional view illustrating a step subsequent to the method of manufacturing the steering illustrated in FIG. 20;

FIG. 22 is a cross-sectional view illustrating a step subsequent to the method of manufacturing the steering illustrated in FIG. 21;

FIG. 23 is a cross-sectional view illustrating a step subsequent to the method of manufacturing the steering illustrated in FIG. 22;

FIG. 24 is a cross-sectional view illustrating a step subsequent to the method of manufacturing the steering illustrated in FIG. 23;

FIG. 25 is a cross-sectional view illustrating a step subsequent to the method of manufacturing the steering illustrated in FIG. 24; and

FIG. 26 is a cross-sectional view illustrating some steps of a method of manufacturing a steering according to a fifth embodiment of the present invention.

### DESCRIPTION OF EMBODIMENTS

### First Embodiment

Hereinafter, a description will be given of a steering according to a first embodiment of the present invention with reference to the accompanying drawings.

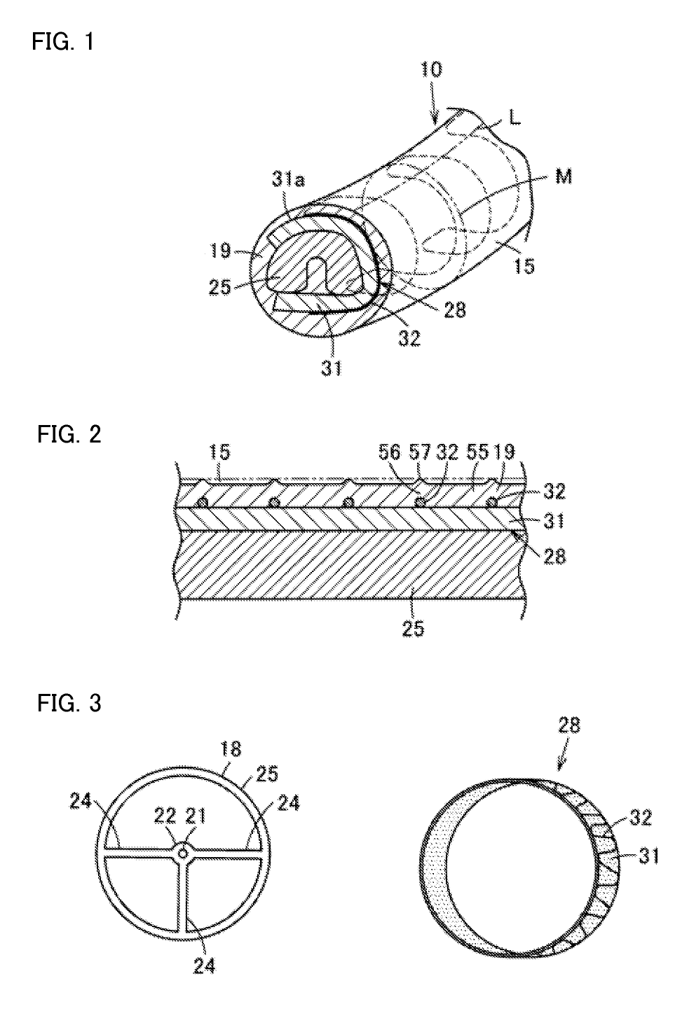

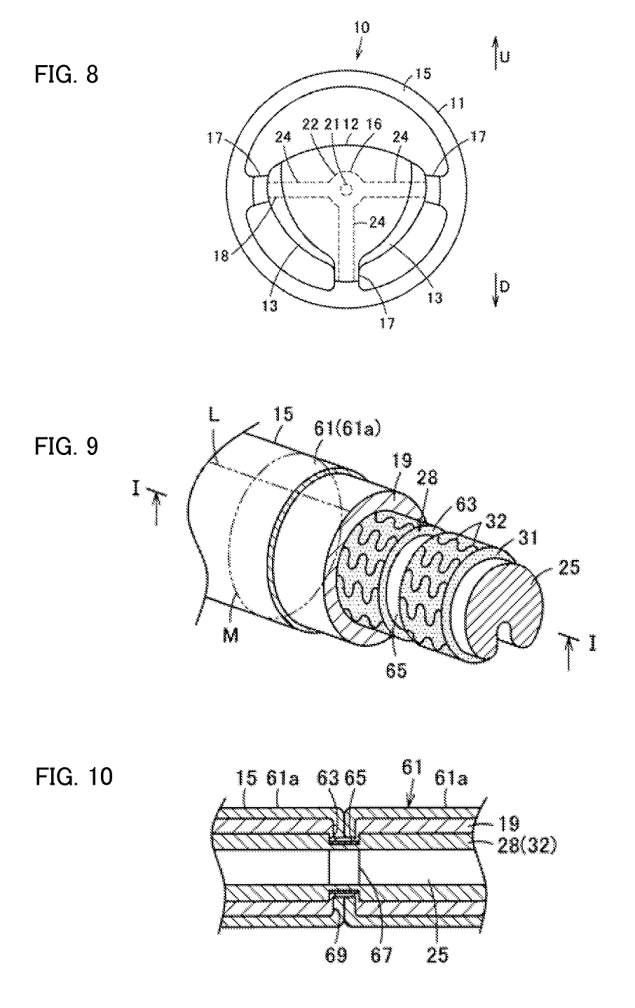

In FIGS. 1 through 8, reference numeral 10 denotes a steering wheel that is a steering of an automobile as a vehicle, for example. Steering wheel 10 includes: steering wheel main body 11, which serves as a steering main body; airbag unit (airbag module) 12, which is a center pad serving as a pad body attached to a passenger side of steering wheel main body 11; and finisher 13, which serves as a decorative member.

Steering wheel 10 is attached to a steering shaft provided obliquely to a vehicle, normally. However, a description will be given while the upper direction of airbag unit 12 (direction indicated by arrow U) is referred to as an upper side; the lower direction thereof (direction indicated by arrow D) is referred to as a lower side; the passenger side, i.e., the front side of airbag unit 12 is referred to as a near side; and the steering shaft side, i.e., the back side of airbag unit 12 is referred to as front side. In other words, the description will be given while the front side of the vehicle, i.e., the upper front side of the windshield side is referred to as a front side; and the rear side of the vehicle, i.e., the lower rear side of the vehicle is referred to as a rear side or a near side.

Steering wheel main body 11 includes: rim portion 15 (ring portion or support portion), which serves as a grip portion at least partially formed along a circumference in an annular shape (doughnut shape) in the first embodiment; boss portion 16, which is positioned at an inner side of rim portion 15; and multiple (three in this embodiment) spoke portions 17, which connect rim portion 15 and boss portion 16. In addition, steering wheel main body 11 includes: core metal 18, which is made of metal; cover portion 19, which is made of a soft synthetic resin and which integrally covers part of core metal 18; and a covering body serving as a covering member that covers the back side of core metal 18, or the like (not illustrated).

Core metal 18 is formed of magnesium aluminum (MgAl) alloy or iron, for example. Core metal 18 includes substantially cylindrical boss 21, which includes a serration structure to mesh with the steering shaft, at a lower portion of the vehicle body side of boss portion 16. In core metal 18, boss plate 22, which forms a core body also called a hub core, is integrally and fixedly attached to boss 21. In addition, spoke cored bars 24, which correspond to spoke portions 17, extend integrally from boss plate 22. Alternatively, spoke cored bars 24 are fixedly attached to boss plate 22 by welding, for example. Moreover, rim core metal 25, which serves as a grip-part core metal corresponding to rim portion 15, is fixedly attached to spoke cored bars 24 of spoke portions 17 by welding, for example.

Cover portion 19 is formed so as to cover the front surface side of the entire circumference of rim core metal 25 of rim portion 15 and the front surface side of spoke cored bars 24 of spoke portions 17 on the side of rim portion 15. Heater 28 is embedded in cover portion 19. In the first embodiment, a microcellular foamed soft polyurethane resin is used for cover portion 19, for example.

Heater 28 integrally includes: porous sheet 31, which serves as a base member; and heating wire 32, which is fixedly attached to front surface 31a of porous sheet 31.

Porous sheet 31 is a general-purpose mesh member such as a sponge, for example. Porous sheet 31 is configured not to block the flow of liquid (fluid) synthetic resin material 34, which is to be described hereinafter and which forms cover portion 19. In addition, porous sheet 31 is configured to be capable of securing a fixedly attaching area for heating wire 32. More specifically, for porous sheet 31, a mesh member having a density equal to 30±5 kg/m³, the number of cells equal to 8±2 cells/25 mm, a tensile strength not greater than 49 kPa, and a stretch rate not greater than 100% is used. Porous sheet 31 is disposed while being bent so as to be wound around along meridian M (small diameter), which is a cross-sectional circumference of rim portion 15.

Heating wire 32 is obtained by providing an insulating film on a front surface of a core line that generates heat during energization. As an example of the core line, a resistance line including nickel, for example, may be adopted. Heating wire 32 is disposed over substantially the entire circumference of rim portion 15 so as to draw a wave alternatively intersecting with latitude line (large diameter) L, which corresponds to the circumference of rim portion 15. Heating wire 32 is connected to a controller circuit (not illustrated) and configured to generate heat when a current is applied by the controller circuit. In addition, heating wire 32 is embedded in cover portion 19 on a surface side of porous sheet 31 which is opposite to a surface side of porous sheet 31 where rim core metal 25 is placed, i.e., heating wire 32 is embedded at a position spaced from rim core metal 25 via porous sheet 31. Heating wire 32 is positioned at a depth equal to or greater than 0.5 min from the front surface of cover portion 19. Heating wire 32 is preferably positioned at a depth of 0.5 mm to 1.5 mm from the front surface of cover portion 19 and is more preferably positioned at a depth of approximately 1.0 mm.

The controller circuit includes a thermostat, for example, and is electrically connected to the both ends of heating wire 32 via a power feeding line (not illustrated). In addition, the controller circuit is placed between a cover body and spoke cored bar 24 of spoke portion 17 of steering wheel main body 11, for example.

The cover body is also called a rear cover, a lower-part cover or a body-cover, and is formed of a synthetic resin or the like and covers the lower side portion of boss portion 16.

Airbag unit 12 includes: a sac-shaped airbag; a resin-made cover body that covers a folded airbag; and an inflator configured to inject a gas. Airbag unit 12 is configured to quickly inject a gas to the inside of the airbag from the inflator to rapidly expand the folded and housed airbag to break the cover body and thus to expand and deploy the airbag in front of a passenger to protect the passenger. Note that, a horn switch mechanism serving as a switch unit may be integrally incorporated into airbag unit 12.

Moreover, finisher 13 is formed of a synthetic resin, for example, in a longitudinal shape in the up and down direction along the both sides of airbag unit 12, for example, and is disposed so as to cover the passenger side of the laterally positioned spoke portions 17. Various operational switches may be incorporated into finisher 13.

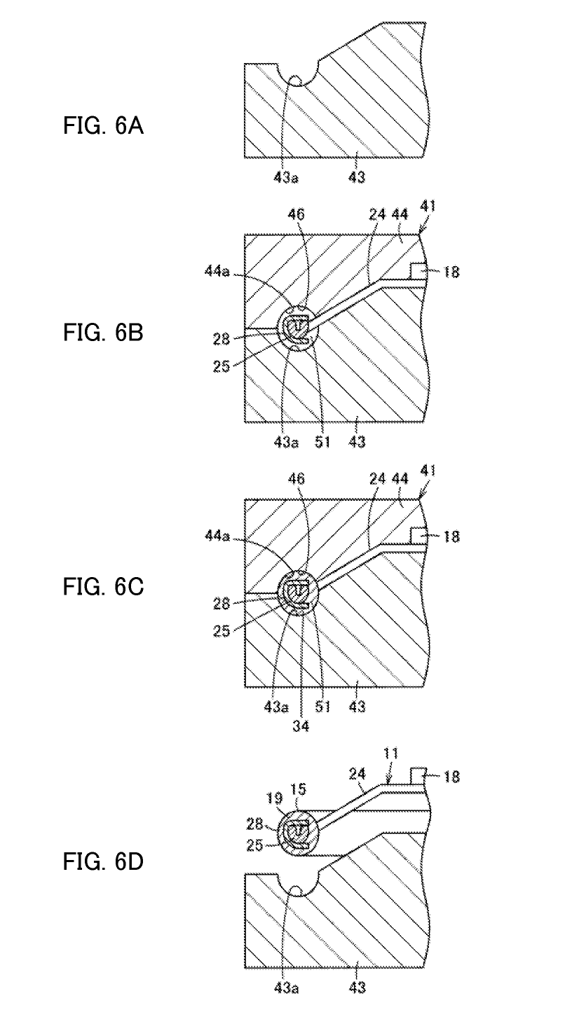

Steering wheel 10 is molded using a shaping mold (mold) 41 illustrated in FIGS. 6B and 6C.

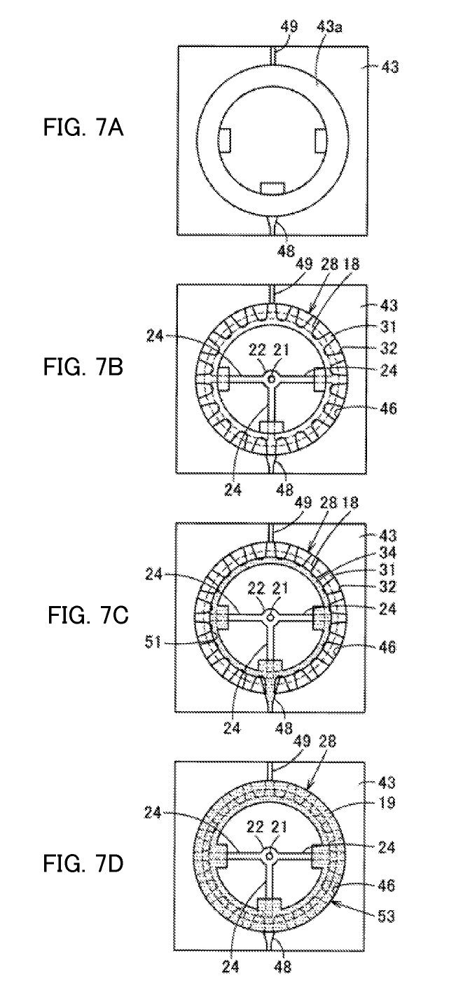

As illustrated in FIGS. 6A to 6D, and 7A to 7D, shaping mold 41 includes first half mold 43 and second half mold 44. Cavity 46 is formed between first and second half molds 43 and 44. Cavity 46 is a cross-sectionally circular shape and is an annular space in front view. Cavity 46 is filled with liquid synthetic resin material 34, which is a reaction mixture that becomes polyurethane after reaction (e.g., mixture of isocyanate and polyol (and antioxidant and/or colorant, for example)). More specifically, semi-cylindrical planar first mold surface 43a is formed on first half mold 43, which faces second half mold 44, and semi-cylindrical planar second mold surface 44a, which is line-symmetric with first mold surface 43a, for example, is formed on second half mold 44, which faces first half mold 43.

In the first embodiment, first half mold 43 serves as a front surface side of rim portion 15 and second half mold 44 serves as a rear surface side of rim portion 15. Moreover, shaping mold 41 includes: a mixing head (not illustrated) for mixing and stirring, and discharging synthetic resin material 34; and a post-mixer for further mixing synthetic resin material 34 discharged from the mixing head. Gate 48 through which synthetic resin material 34 mixed by the post-mixer is injected into cavity 46 is formed so as to extend from first mold surface 43a of first half mold 43, for example. Furthermore, gas vent 49 for releasing the gas from cavity 46 is formed so as to extend from first mold surface 43a of first half mold 43, for example.

Note that, shaping mold 41 is placed horizontally and used when synthetic resin material 34 is injected in order that cavity 46 is surely filled with synthetic resin material 34 before viscosity increases due to reaction of synthetic resin material 34.

Gate 48 is a gate so called a fan gate and is formed so as to gradually increase in diameter in a direction from the post-mixer to cavity 46. Note that, in the first embodiment, gate 48 is disposed at a position corresponding to six o'clock on an analog clock as viewed from top of shaping mold 41, for example.

Gas vent 49 is a vent so called an air vent and is formed in a linear trench. In the first embodiment, gas vent 49 is disposed at a position corresponding to twelve o'clock on an analog clock as viewed from top of shaping mold 41, for example, i.e., a position opposite to gate 48.

During the manufacturing of steering wheel 10, heater 28 is formed by cutting porous sheet 31 into a belt-like shape having a width of 50 mm, for example, and fixedly attaching heating wire 32 to front surface 31a of porous sheet 31 in a wave shape alternatively intersecting in the longitudinal direction, for example (FIG. 3). During this process, heating wire 32 can be fixedly attached to front surface 31a of porous sheet 31 by bonding, welding, or sewing, for example. In the first embodiment, heating wire 32 is fixed to front surface 31a of porous sheet 31 by bonding, for example.

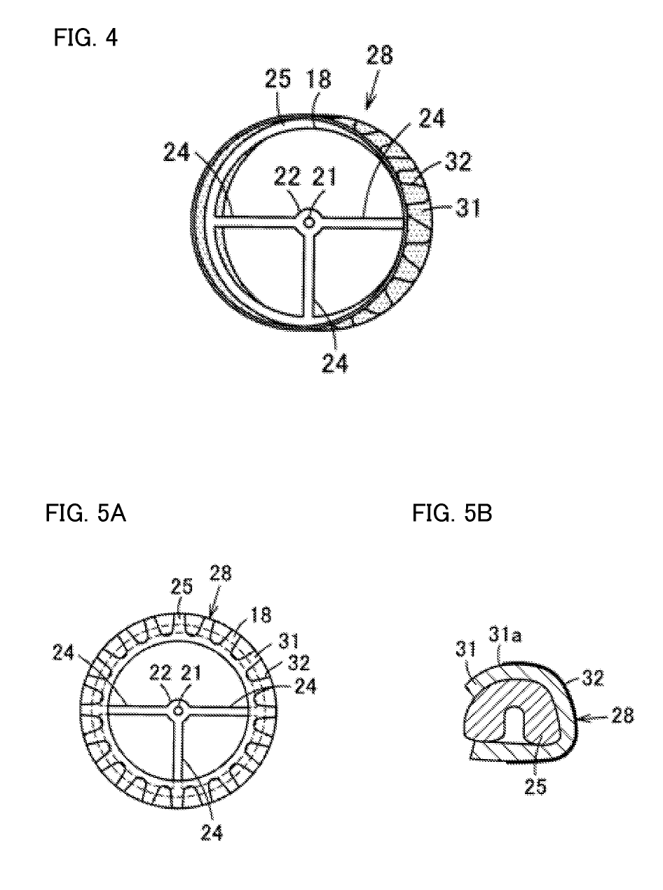

Heater 28 is formed in a ring shape having an outer circumferential length shorter than the outer circumferential length of rim core metal 25 and is wound around rim core metal 25 (see, FIG. 4). In the first embodiment, the circumferential length of ring shaped heater 28 is set to approximately 1000 mm. Ring shaped heater 28 is formed by sewing end sides of porous sheet 31 in such a way that heater 28 can be set to the outer circumferential side of rim core metal 25 in a state where heater 28 is stretchable approximately 10% with respect to the inner circumferential length of rim core metal 25.

During this process, if heater 28 is stretched excessively with respect to the inner circumferential length of rim core metal 25, porous sheet 31 in contact with the outer circumferential side of rim core metal 25 becomes too thin. Meanwhile, if heater 28 is placed over the outer circumference of rim core metal 25 without applying any tension, heater 28 may shift in position during the manufacturing. It is preferable to fix ring shaped heater 28 in such a way that the lateral sides of porous sheet 31 are fixed to the inner circumferential side of rim core metal 25 so as to prevent the lateral sides of porous sheet 31 from spreading with respect to rim core metal 25. A band or hook may be used for this fixing method. In the first embodiment, a method using rough-sewing, for example, may be employed as a method of fixing the lateral sides of porous sheet 31 with each other.

Moreover, the inner circumferential side of rim core metal 25 is not covered by heater 28 so that the flow of liquid synthetic resin material 34 injected into cavity 46 is not blocked. Moreover, heater 28 is wound around rim core metal 25 with heating wire 32 placed on the outer side of heater 28 in order to prevent heating wire 32 and rim core metal 25 from being close to (in contact with) each other (FIGS. 5A and 5B).

First, as illustrated in FIGS. 6A to 6D and 7A to 7D, shaping mold 41 is opened (FIGS. 6A and 7A). Cavity 46 is formed by placing core metal 18 formed by winding heater 28 around rim core metal 25 on first half mold 43 placed horizontally, first, and mold-matching (closing mold) first half mold 43 and second half mold 44 (FIGS. 6B and 7B). More specifically, rim core metal 25 and heater 28 are placed in cavity 46. In this state, flow passage 51 where no heater 28 is placed is formed on the inner circumferential side of rim core metal 25.

Subsequently, synthetic resin material 34 discharged from the mixing head is stirred and mixed by the post-mixer and injected into the inside of cavity 46 via gate 48 (FIGS. 6C and 7C). Porous sheet 31 has a density equal to 30±5 kg/m³, and the number of cells equal to 8±2 cells/25 mm, i.e., has a coarse mesh. Thus, porous sheet 31 does not block the flow of synthetic resin material 34 within cavity 46 when synthetic resin material 34 is injected into cavity 46. Moreover, shaping mold 41 is placed horizontally in a state where heater 28 (porous sheet 31) does not cover the inner circumferential side of rim core metal 25 to secure flow passage 51. Accordingly, cavity 46 is filled with synthetic resin material 34 before viscosity increases due to reaction of synthetic resin material 34, and synthetic resin material 34 reacts within cavity 46 and becomes polyurethane. As a result, cover portion 19 is formed (FIGS. 6D and 7D).

More specifically, causing a large amount of synthetic resin material 34 to flow into cavity 46 through gate 48 causes synthetic resin material 34 to flow along the inner circumferential side of rim core metal 25 via flow passage 51. Thus, a flow path through which synthetic resin material 34 flows with foams toward the flowing end (12 o'clock position on an analog clock, which corresponds to the upper side position of rim portion 15) is formed. In addition, synthetic resin material 34 generates reaction heat and impregnates the mesh of porous sheet 31 of heater 28 during reaction. Accordingly, synthetic resin material 34 is solidly fixed to cover portion 19 because of the anchor effect without use of an adhesive, for example.

First and second half molds 43 and 44 are separated as mold-opening, intermediate body 53 including cover portion 19 is de-molded. Subsequently, various surface treatments are applied to rim portion 15 (cover portion 19) as appropriate, and heating wire 32 and the controller circuit are electrically connected, and airbag unit 12 and finisher 13 are attached to intermediate body 53. Thus, steering wheel 10 is completed.

As described above, according to the first embodiment, porous sheet 31 to which heating wire 32 of heater 28, which is embedded in cover portion 19, is fixed has a density equal to 30±5 kg/m³, and the number of cells equal to 8±2 cells/25 mm. Porous sheet 31 of heater 28 is wound around rim core metal 25, and cover portion 19 is molded.

Accordingly, heater 28 can be embedded into cover portion 19 simultaneously with molding of cover portion 19 without blocking, by porous sheet 31, the flow of liquid synthetic resin material 34, which forms cover portion 19. More specifically, heater 28 can be easily buried into cover portion 19 by a single molding process. Accordingly, it is possible to improve the productivity and to reduce the manufacturing costs, and the pores of porous sheet 31 can be surely filled with the synthetic resin forming cover portion 19, and heater 28 can be surely fixed within cover portion 19.

Moreover, when rim portion 15 is held, there is no difference in feeling between porous sheet 31 and cover portion 19, and uniform tactile impression can be obtained regardless of the presence or absence of heater 28.

While heating wire 32 of heater 28 is dimensionally stable, cover portion 19 shrinks along with the end of reaction of synthetic resin material 34 in general. For this reason, as illustrated in FIG. 2, a difference between the shrinkage inhibition due to the presence of heating wire 32 and the normal shrinkage occurs between position 55 where no heating wire 32 is present so that a change in dimension is unlikely to occur and position 56 where heating wire 32 is present and covered, causing round 57, which is a fine irregularity in rim portion 15. Round 57 has a size of 50 to 100 μm in human eyes and is observable, thus degrading the appearance. For this reason, the following inequality is set: (b(1−R)+c)−(a(1−R))<100 μm, where “a” represents the thickness of porous sheet 31, “b” represents the depth from the surface of cover portion 19 to heating wire 32, “c” represents the difference between the thickness and depth (c=a−b), and “R” represents the shrink rate. When rim portion 15 is configured in such a way that this inequality holds true, round 57 can be suppressed while the heat generated by heating wire 32 can be surely transmitted to the hands of the driver holding rim portion 15.

More specifically, in the first embodiment, depth “b” is set to a value equal to or greater than 0.5 mm, and preferably between 0.5 mm and 1.5 mm. Thus it is made possible to surely suppress the formation of round 57 due to heating wire 32 and also to surely transmit the heat generated by heating wire 32 to the hands of the driver holding rim portion 15. In addition, it is made possible to more surely suppress a heat loss by making it harder for the heat from heating wire 32 to be transmitted to rim core metal 25, which is made of a metal having a relatively low specific heat. Moreover, depth “b” is preferably set to approximately 1.0 mm. This setting improves the flow of synthetic resin material 34 on the front surface side during molding and thus suppresses the generation of surface voids (air holes) and round 57. In other words, the appearance quality further improves.

Reducing the thickness of heating wire 32 is also effective in suppressing round 57. Thus, use of heating wire 32 having a wire diameter of 0.9 mm can more surely suppress round 57.

As a conclusion, steering wheel 10 according to the first embodiment is a polyurethane steering wheel having a favorable temperature increase and tactile impression on the front surface of the steering wheel, and no one can tell (it is hard to tell) from outside that heating wire 32 is embedded in the steering wheel. In addition, steering wheel 10 according to the first embodiment basically requires no surface finishing for rim portion 15 such as leather wrapping, so that the manufacturing costs of steering wheel 10 can be more surely reduced, and steering wheel 10 can be provided less expensively.

Moreover, heater 28 is wound around rim core metal 25 with heating wire 32 placed on the outer side of rim core metal 25. This configuration makes it harder for heating wire 32 to block the flow of synthetic resin material 34 through flow passage 51 formed on the inner circumferential side of rim core metal 25. Moreover, heating wire 32 can be surely spaced from rim core metal 25, so that the heat from heating wire 32 can be more surely transmitted to the hands of the driver holding the rim portion 15 rather than being transmitted towards rim core metal 25.

### Second Embodiment

Next, a description will be given of a second embodiment with reference to FIGS. 9 through 12. Note that, the components and effects identical to those of the first embodiment are assigned the same reference numerals, and the description of these components and effects will not be repeated.

The second embodiment is different from the first embodiment in that rim portion 15 includes skin body 61 on the surface of cover portion 19 as illustrated in FIGS. 9 and 10.

Skin body 61 is made of leather (artificial leather), for example, or a synthetic resin (polyurethane rubber). Skin body 61 extends in a longitudinal direction that is a direction along latitude line L of rim portion 15 and extends in a width direction (lateral direction) that is a short-side direction along meridian M of rim portion 15. Skin body 61 is divided into multiple skin body pieces 61a. Note that, skin body 61 not only refers to leather but also an appropriate thin-skin member (including leather or artificial leather, for example) that covers cover portion 19 of rim portion 15.

Heater 28 includes at least one recess portion 63, which has a smaller thickness than the other portion of porous sheet 31, and which extends linearly along the direction intersecting with (orthogonal to) the longitudinal direction in porous sheet 31. Recess portion 63 is positioned in the direction along meridian M in a state where heater 28 (porous sheet 31) is wound around rim core metal 25. Tape 65, which is a belt shaped fixing member formed of aluminum, for example, is attached to recess portion 63. Tape 65 is used to temporarily fix heater 28 to rim core metal 25 of core metal 18. Moreover, heater 28 includes multiple (e.g., three) heating wires 32, which are disposed on the side of front surface 31a of porous sheet 31 so as not to intersect with each other.

Marking 67 is placed in advance along meridian M at a certain position of rim core metal 25 where heater 28 (porous sheet 31) is fixed using tape 65. Accordingly, porous sheet 31 of heater 28 is wound in such a way that recess portion 63 is located at the position of marking 67.

Moreover, cover portion 19 includes cover recess portion 69, which is a thin portion having a smaller thickness than the other portion of cover portion 19, and which is formed by making a recess along meridian M in a position opposite to recess portion 63 of heater 28. Cover recess portion 69 extends annularly over the entire circumference of meridian M of cover portion 19. Moreover, the ends of skin body pieces 61a of skin body 61 adjacent to each other are bent and fixedly placed into cover recess portion 69.

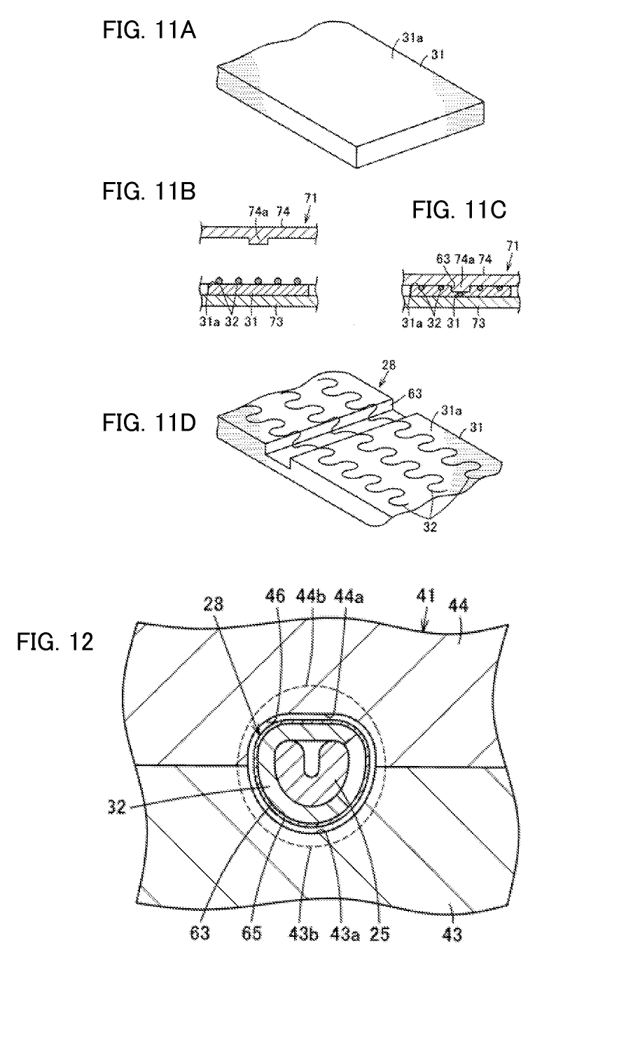

Heater 28 is hot-press shaped using press-die 71 illustrated in FIGS. 11B and D.

Press-die 71 includes plate-shaped first half press-die 73 and second half press-die 74. Second half press-die 74 includes press protruding portion 74a, which is provided in a protruding manner toward first half press-die 73 to form recess portion 63. First, porous sheet 31, which has been cut into a belt-like shape (FIG. 11A), is placed between heated first and second half press-dies 73 and 74, while multiple heating wires 32 are each arranged in a wave like shape on front surface 31a of porous sheet 31 (FIG. 11B). Porous sheet 31 and heating wires 32 are thus held between first and second half press-dies 73 and 74 (FIG. 11C). Thus, heating wires 32 are embedded in front surface 31a of porous sheet 31, and porous sheet 31 partially melts, and heating wires 32 are welded and fixed to porous sheet 31, while recess portion 63 is formed simultaneously (FIG. 11D). More specifically, recess portion 63 is formed simultaneously during the process of fixing heating wires 32 to porous sheet 31. In this state, all heating wires 32 are positioned on the side of front surface 31a of porous sheet 31 including recess portions 63.

As described above, heater 28, which is formed by fixing heating wires 32 to porous sheet 31 (FIG. 11D), is formed in a ring shape having an outer circumferential length shorter than the outer circumferential length of rim core metal 25 and is wound around rim core metal 25 as in the case of the first embodiment. More specifically, heater 28 is formed by sewing end sides of porous sheet 31 so that heater 28 can be set to the outer circumferential side of rim core metal 25 in a state where heater 28 is stretchable approximately 10% with respect to the inner circumferential length of rim core metal 25. Tape 65 is then would around rim core metal 25 at least one turn along the direction of meridian M and fixed to recess portion 63 in order to prevent the lateral sides of porous sheet 31 from spreading with respect to rim core metal 25.

Core metal 18, which is formed by winding heater 28 around rim core metal 25, is inserted into (set to) shaping mold 41, and cavity 46 is filled with synthetic resin material 34 to mold cover portion 19 as in the case of the first embodiment. Shaping mold 41 includes protruding portions 43b and 44b, which are formed at positions corresponding to recess portions 63 of first mold surface 43a of first half mold 43 and second mold surface 44a of second half mold 44, respectively, in a band like shape, so as to protrude towards recess portions 63, respectively (FIG. 12). Accordingly, cover portion 19, which is formed by molding, includes cover recess portions 69 (FIG. 10) along meridian M at the positions corresponding to recess portions 63.

Furthermore, skin body 61 is wound around intermediate body 53, which has been de-molded from shaping mold 41. Skin body 61 is formed by winding multiple skin body pieces 61a around cover portion 19 along meridian M. In addition, the end portions of each skin body piece 61a are bent and placed into cover recess portion 69. Skin body pieces 61a are attached to cover portion 19 by sewing or the like at an inner circumference position of cover portion 19 (rim portion 15) so as to cover the planar surface of cover portion 19 and to be substantially flush with each other.

As described above, according to the second embodiment, recess portions 63 for fixing (temporarily fixing) heater 28 to rim core metal 25 by tape 65 are provided to porous sheet 31. Thus, positioning of heater 28 with respect to rim core metal 25 is made easy and can be improved in accuracy, and the positioning accuracy of heater 28 after molding of cover portion 19 can be further improved. More specifically, it is made possible to stabilize the temperature increase by heater 28 (heating wires 32) and also to surely reduce uplifting of heater 28 towards the front surface of cover portion 19 while ensuring a certain level of the external appearance.

Recess portions 63 are each positioned at the same row as the position where cover recess portion 69 is formed by making a recess for placing and fixing the end portion of skin body piece 61a of skin body 61, which covers cover portion 19. Thus, a favorable appearance is achieved without sink marks or the like otherwise generated on the surface of cover portion 19 due to recess portions 63. Moreover, heater 28 is placed in the same row as cover recess portions 69 by partially reducing the thickness of heater 28 at the positions corresponding to recess portions 63. More specifically, heater 28 is configured to be insert-molded with respect to cover portion 19, and heater 28 (heating wires 32) can be surely disposed at the positions of cover recess portions 69 each having a reduced thickness in cover portion 19.

Moreover, recess portions 63 can be formed simultaneously in the process of fixing heating wires 32 to porous sheet 31. Accordingly, the process of forming recess portions 63 is no longer required, so that it is possible to prevent an increase in the manufacturing costs associated with an increase in the number of manufacturing steps.

Note that, heating wires 32 can be fixed to porous sheet 31 by bonding, pressure-bonding, or sewing in the second embodiment.

### Third Embodiment

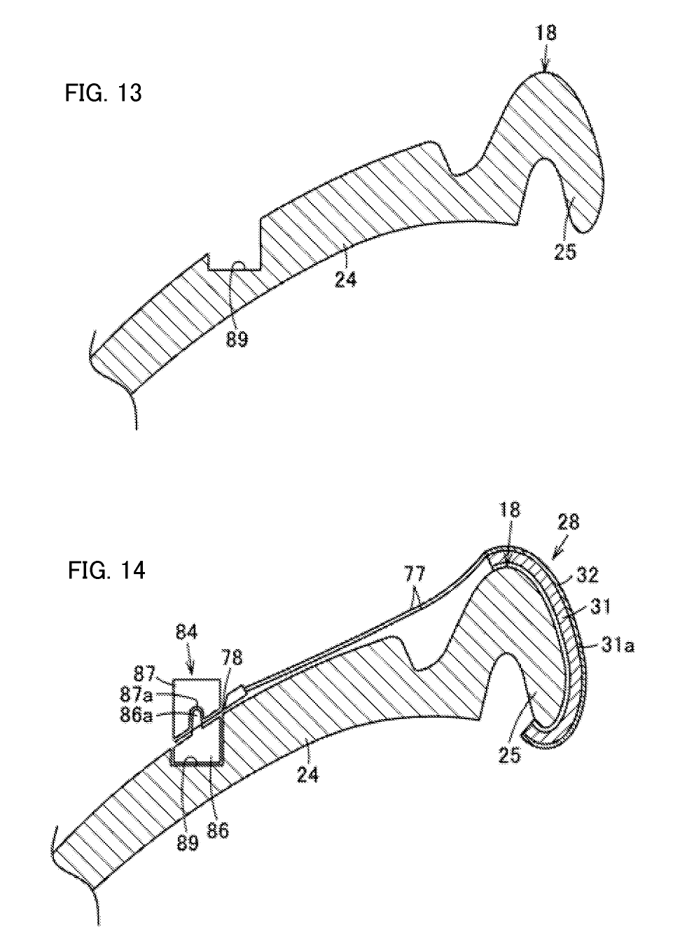

Next, a description will be given of a third embodiment with reference to FIGS. 13 through 19. Note that, the components and effects identical to those of the first or the second embodiment are assigned the same reference numerals, and the description of these components and effects will not be repeated.

The third embodiment is different from each of the embodiments described above in that a structure to electrically connect heating wire 32 and the controller circuit is set in spoke cored bar 24 (spoke portion 17).

More specifically, heater-side connection terminal 78, which is a first connection terminal, is electrically connected to heating wire 32 of heater 28 via heater-side lead line 77, which is a first lead line. Moreover, vehicle-side connection terminal (circuit-side connection terminal) 82 is electrically connected to the controller circuit via harness 80 and vehicle-side lead line (circuit-side lead line) 81, which are connection members.

Connection terminals 78 and 82 are held by fixing member 84 in a state where connection terminals 78 and 82 are electrically connected to each other. Fixing member 84 is attached to spoke cored bar 24 of spoke portion 17.

Heater-side lead 77 is a flat braided wire, for example, and is positioned along spoke portion 17 (spoke cored bar 24).

Heater-side connection terminal 78 is formed in an annular shape (ring shape) using a metal having a small electric resistance (conductive metal) such as copper or aluminum, for example. Examples of heater-side connection terminal 78 include a general-purpose ring shaped solderless terminal.

Meanwhile, harness 80 is configured to be detachably connected to a connection portion (not illustrated) electrically connected to the controller circuit. Harness 80 is configured to electrically connect the controller circuit and vehicle-side connection terminal 82 when connected to this connection portion.

Vehicle-side lead 81 is a flat braided wire, for example, as in the case of heater-side lead 77, and is positioned along spoke portion 17 (spoke cored bar 24).

Moreover, vehicle-side connection terminal 82 is formed in an annular shape (ring shape) using a metal having a small electric resistance (conductive metal) such as copper or aluminum, for example. Examples of vehicle-side connection terminal 82 include a general-purpose ring shaped solderless terminal. More specifically, an element having a shape and material quality identical to the heater-side connection terminal 78 may be used for vehicle-side connection terminal 82.

An elastic synthetic resin such as polyurethane or soft vinyl chloride is favorably used for fixing member 84. Fixing member 84 is formed in a columnar shape, for example, and is divided into pieces corresponding to the front and rear of steering wheel 10 (upper and lower portions in FIG. 14). More specifically, fixing member 84 includes first fixing member main body 86, which is fixed to spoke cored bar 24, and second fixing member main body 87, which is a portion resulting from the division and detachable with respect to first fixing member main body 86.

A fitting protruding portion is provided to one of first and second fixing member main bodies 86 and 87 and a fitting recess portion is provided to the other one. First and second fixing member main bodies 86 and 87 are configured to form male-female connection by fitting the fitting protruding portion to the fitting recess portion. In the third embodiment, fitting protruding portion 86a is provided to first fixing member main body 86, and fitting recess portion 87a is provided to second fixing member main body 87. However, a fitting recess portion may be provided to first fixing member main body 86, and a fitting protruding portion may be provided to second fixing member main body 87.

First fixing member main body 86 is fixed to fixing member 89, which is a terminal fixing portion provided to the near side (passenger side) of spoke cored bar 24. The division line of first and second fixing member main bodies 86 and 87 follows a virtual outline on the near side of spoke cored bar 24. Accordingly, fitting protruding portion 86a of first fixing member main body 86 is configured to protrude from the near side of spoke cored bar 24.

Connection terminals 78 and 82 are placed one on top of the other and fixed to fitting protruding portion 86a of first fixing member main body 86 in such a way that fitting protruding portion 86a is inserted through connection terminals 78 and 82. More specifically, connection terminals 78 and 82, which are fixed in this manner, come into pressure contact with each other and are thus electrically connected when fixing member 84 is pressed by finisher 13 in a state where connection terminals 78 and 82 are held between first fixing member main body 86 and second fixing member main body 87.

Finisher 13 includes retainer rib 13a, which is provided on the back side of finisher 13 in a protruding manner, and which serves as a retainer portion to push fixing member 84 from above, i.e., to bring second fixing member main body 87 into pressure contact with first fixing member main body 86. Retainer rib 13a is configured to push and retain assembled fixing member 84 in order to prevent assembled fixing member 84 from being disassembled due to vibrations during running of the vehicle, for example. Retainer rib 13a is formed so as to avoid leads 77 and 81 and to enclose fixing member 84 (second fixing member main body 87). In the third embodiment, retainer rib 13a is formed in a cylindrical shape, for example, and configured to prevent connection terminals 78 and 82 from turning and thus shifting in position.

In the third embodiment, fixing portion 89 is formed in a hole portion having a diameter of 5 mm, and a depth of approximately, 3 mm to 6 mm, for example, and provided as a recess along the axis direction of steering wheel 10 (core metal 18). Note that, in the third embodiment, fixing member 89 and fixing member 84, which is fixed by the fixing member 89, are set to spoke portions 17 on the lateral sides of airbag unit 12, respectively, among spoke portions 17 (spoke cored bars 24). In other words, the lateral sides of airbag unit 12 refer to spoke portions 17 (spoke cored bars 24) extending in the directions of three o'clock and nine o'clock on an analog clock, respectively, as viewed from the front side of steering wheel 10 (core metal 18). More specifically, heater 28 is set while divided into left and right portions of rim portion 15 of steering wheel 10, and each of the left and right portions covers substantially a half of the circle and is electrically connected to the controller circuit.

Note that, the following components are basically disposed symmetrically: fixing portions 89; fixing members 84; heaters 28; heater-side leads 77; heater-side connection terminals 78; harnesses 80; vehicle-side leads 81; vehicle-side connection terminals 82; and retainer ribs 13a. Thus, for the components mentioned above, the components on one side are illustrated in the drawings, and illustration of these components on the other side is omitted.

Furthermore, escape portion 93 for avoiding interference with second fixing member main body 87 of fixing member 84 during molding is provided as a recess in first mold surface 43a of first half mold 43 of shaping mold 41.

During the manufacturing of steering wheel 10, as in the case of the embodiments mentioned above, heater 28 is wound around rim core metal 25 and fixed. Moreover, in the third embodiment, first fixing member main body 86 of fixing member 84 is fittingly attached to fixing portion 89 of spoke cored bar 24. Heater-side connection terminal 78 is placed in such a way that fitting protruding portion 86a of first fixing member main body 86 is inserted through heater-side connection terminal 78, while heating wire 32 of heater 28 and electrically connected heater-side lead 77 are placed along spoke cored bar 24. Second fixing member main body 87 is placed over first fixing member main body 86, and fitting protruding portion 86a is fitted to fitting recess portion 87a. First and second fixing member main bodies 86 and 87 are fixed to each other while heater-side connection terminal 78 is held in between (FIGS. 13 and 14).

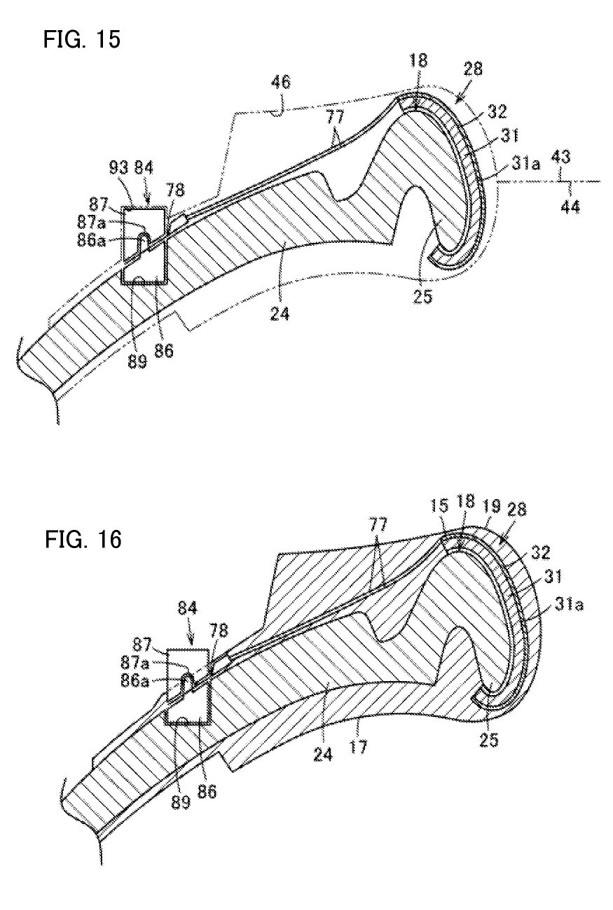

Next, core metal 18 to which heater 28 is attached is inserted into cavity 46 of shaping mold 41. In this state, second fixing member main body 87, which protrudes from spoke cored bar 24, is fitted to escape portion 93 of shaping mold 41 (FIG. 15). In this state, the rear surface of second fixing member main body 87 (top surface in FIG. 15) is brought into close contact with the bottom of escape portion 93 without any gap.

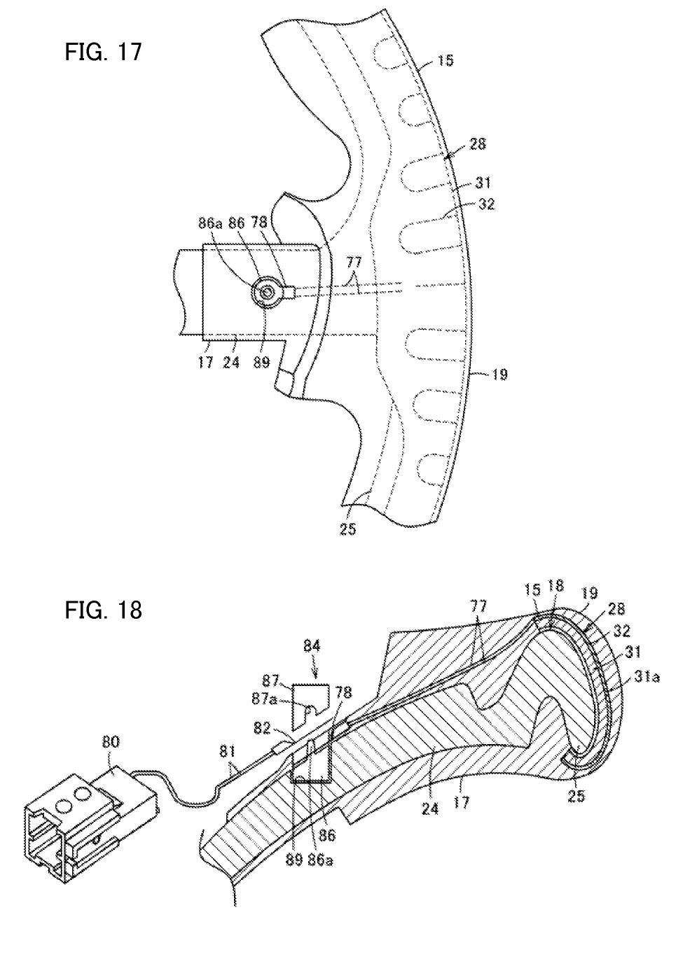

Cavity 46 is then filled with synthetic resin material 34 to mold cover portion 19 (FIGS. 16 and 17). During this process, fixing member 84 and heater-side connection terminal 78 do not move because they are fixed by male-female connection between fitting protruding portion 86a and fitting recess portion 87a, as well as the mold-locking force of first and second half molds 43 and 44. In addition, since second fixing member main body 87 is fitted to escape portion 93 substantially without any gap, fixing member 84 is not entirely covered by synthetic resin in the molded state, so that second fixing member main body 87 is exposed. Note that, heater-side lead 77 may or may not be embedded in cover portion 19.

Moreover, second fixing member main body 87 is removed from first fixing member main body 86. Vehicle-side connection terminal 82, which is electrically connected to harness 80 via vehicle-side lead 81, is placed over heater-side connection terminal 78 in such a way that fitting protruding portion 86a of first fixing main body 86 is inserted through vehicle-side connection terminal 82. Second fixing member main body 87 is then fixed to first fixing member main body 86 again by the fitting of fitting protruding portion 86a and fitting recess portion 87a, and connection terminals 78 and 82 are held in between and brought into pressure contact, and are electrically connected (FIG. 18). Harness 80 is connected to a connector that is a connection member of the controller circuit.

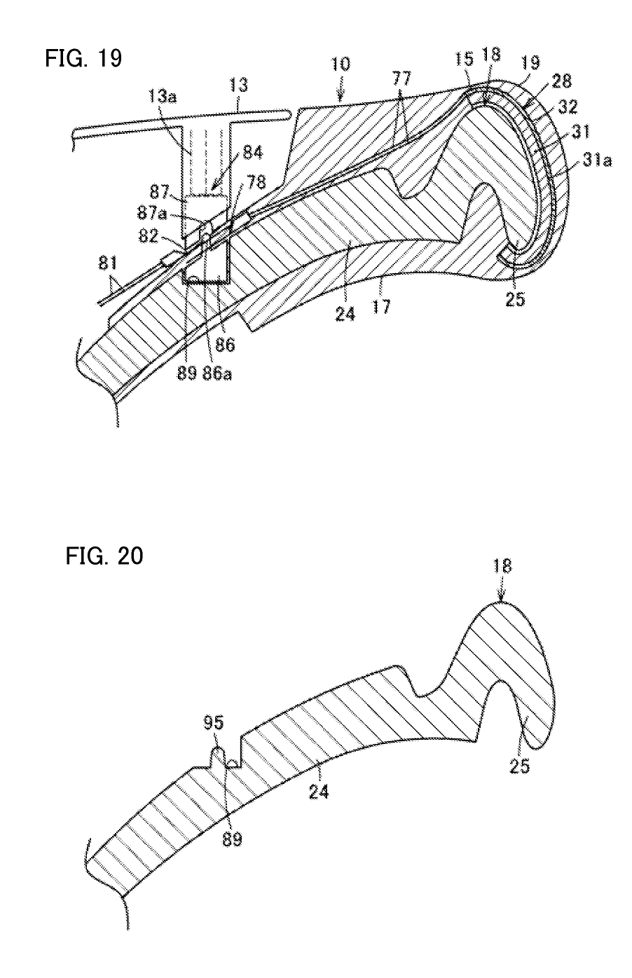

Airbag unit 12 and finisher 13 are then attached to complete steering wheel 10 (FIG. 19). During this process, finisher 13 encloses and pushes second fixing member main body 87 of fixing member 84 towards first fixing member main body 86 by retainer rib 13a. Thus, finisher 13 holds first and second fixing member main bodies 86 and 87 in order to prevent them from being disassembled and retains electrical connection while preventing connection terminals 78 and 82 from turning and thus shifting in position.

As described above, according to the third embodiment, fixing member 84, which holds heater-side connection terminal 78 and vehicle-side connection terminal 82 so as to electrically connect heater 28 and the controller circuit, is configured to be held by fixing portion 89, which is provided in spoke cored bar 24. Core metal 18 in a state where heater-side connection terminal 78 is held using fixing member 84 is inserted together with heater 28 into cavity 46 to mold cover portion 19. Thus, cover portion 19 can be manufactured without any increase in the number of manufacturing steps even though steering wheel 10 has heater 28 in rim portion 15.

Meanwhile, only heater-side lead 77 and heater-side connection terminal 78 are inserted into shaping mold 41. Thus, the number of components to be inserted into shaping mold 41 is kept at minimum, and it is made possible to suppress damage to shaping mold 41 and heater-side connection terminal 78.

Moreover, heater-side connection terminal 78 is covered by second fixing member main body 87 during molding. This configuration makes it harder for the synthetic resin to be attached to heater-side connection terminal 78 and thus makes it harder for the synthetic resin to block electrical conduction with vehicle-side connection terminal 82. In addition, the process of removing synthetic resin is not required. Thus, the productivity can be further improved.

Moreover, the position where fixing member 84 and fixing portion 89 are set is a position on the back surface side of finisher 13, i.e., the position covered by finisher 13. For this reason, no change in the shape of finisher 13, for example, is required regardless of the presence or absence of heater 28. Thus, finisher 13 and the like can be shared between steering wheels 10 with heater 28 and without heater 28.

Connection terminals 78 and 82 are pushed via finisher 13, so that the connection between connection terminals 78 and 82 is unlikely to be removed by vibrations of the vehicle body, for example.

### Fourth Embodiment

Next, a description will be given of a fourth embodiment with reference to FIGS. 20 through 25. Note that, the components and effects identical to those of the embodiments described above are assigned the same reference numerals, and the description of these components and effects will not be repeated.

The fourth embodiment is different from the third embodiment in that fixing portion 89 according to the third embodiment is formed in a so called rack shape.

More specifically, fixing portion 89 is formed in a rack shape in spoke cored bar 24. Fixing member fixing portion 95, which is fitted to fixing member 84, is provided to fixing portion 89 in a protruding manner.

Fixing member 84 is not divided and includes: holding protruding portion 97, which is inserted through connection terminals 78 and 82, and which is formed in a protruding manner; and insertion recess portion 98, which forms male-female connection with fixing member fixing portion 95, and which is formed by making a recess. Furthermore, fitting recess portion 13b, which forms male-female connection with holding protruding portion 97, is formed at a leading end portion of retainer rib 13a of finisher 13.

Moreover, escape portion 93 of shaping mold 41 is formed as a recess on first mold surface 43a of first half mold 43 so as to avoid interference with fixing member 84 and holding protruding portion 97 during molding. Accordingly, escape portion 93 includes escape recess portion 93a into which holding protruding portion 97 is inserted.

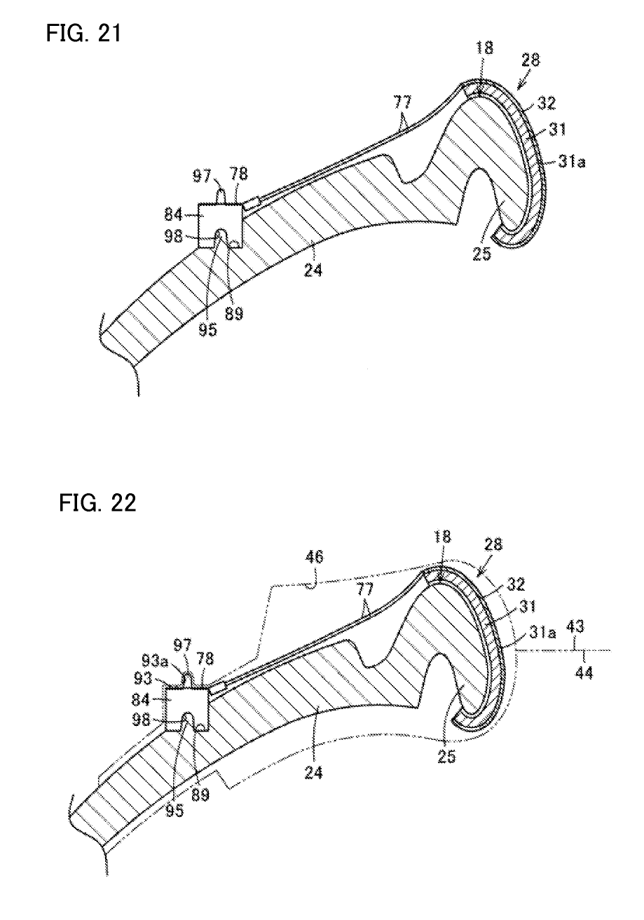

Moreover, during the manufacturing of steering wheel 10, as in the case of the embodiments described above, heater 28 is wound around rim core metal 25 and fixed. Moreover, in the fourth embodiment, fixing member 84 is attached in such a way that fixing member fixing portion 95, which is provided to fixing portion 89 of spoke cored bar 24, is fittingly inserted into insertion recess portion 98 of fixing member 84. Heater-side connection terminal 78 is placed in such a way that holding protruding portion 97 of fixing member 84 is inserted through heater-side connection terminal 78, while heater-side lead 77, which is electrically connected to heating wire 32 of heater 28, is placed along spoke cored bar 24 (FIGS. 20 and 21).

Subsequently, core metal 18 to which heater 28 is attached is inserted into cavity 46 of shaping mold 41. In this state, fixing member 84 and holding protruding portion 97, which protrude from spoke cored bar 24, are fitted to escape portion 93 and escape recess portion 93a of shaping mold 41 (FIG. 22). In this state, fixing member 84 and holding protruding portion 97 are brought into contact with escape portion 93 and escape recess portion 93a without any gap.

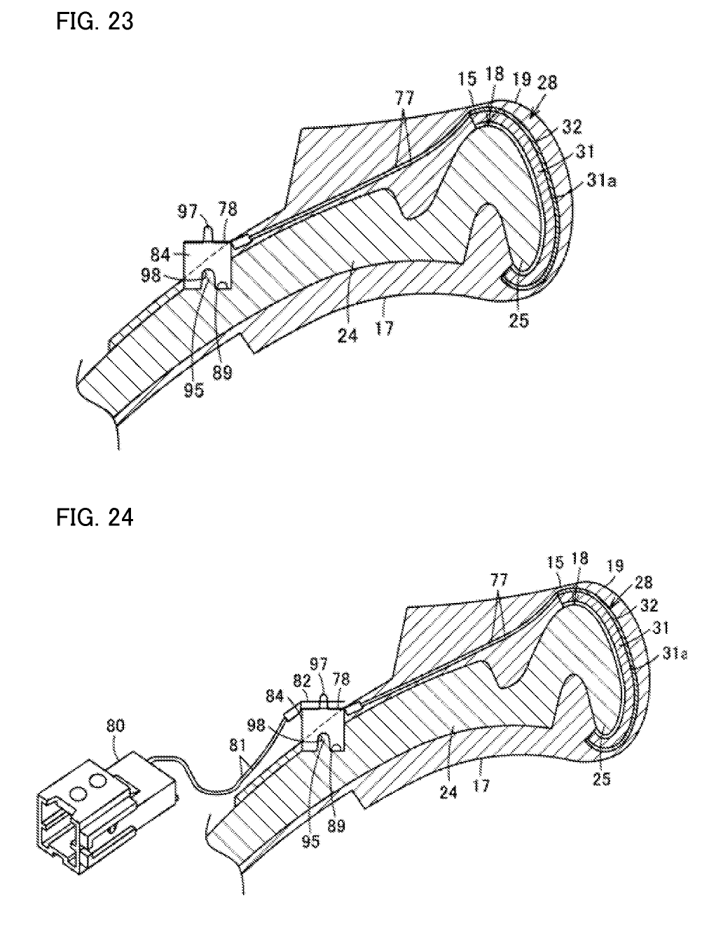

Cavity 46 is then filled with synthetic resin material 34 to mold cover portion 19 (FIG. 23). During this process, fixing member 84 and heater-side connection terminal 78 are fixed by the mold-locking force of first and second half molds 43 and 44 and do not move. Since fixing member 84 is fitted to escape portion 93 substantially without any gap, fixing member 84 is not entirely covered by synthetic resin in the molded state, so that holding protruding portion 97 and heater-side connection terminal 78 are exposed. Note that, heater-side lead 77 may be or may not be embedded in cover operation 19.

Vehicle-side connection terminal 82, which is electrically connected to harness 80 via vehicle-side wire 81, is placed over or under heater-side connection terminal 78 in such a way that holding protruding portion 97 of fixing member 84 is inserted through vehicle-side connection terminal 82, to thereby electrically connect connection terminals 78 and 82 (FIG. 24). Harness 80 is connected to a connecter of the controller circuit.

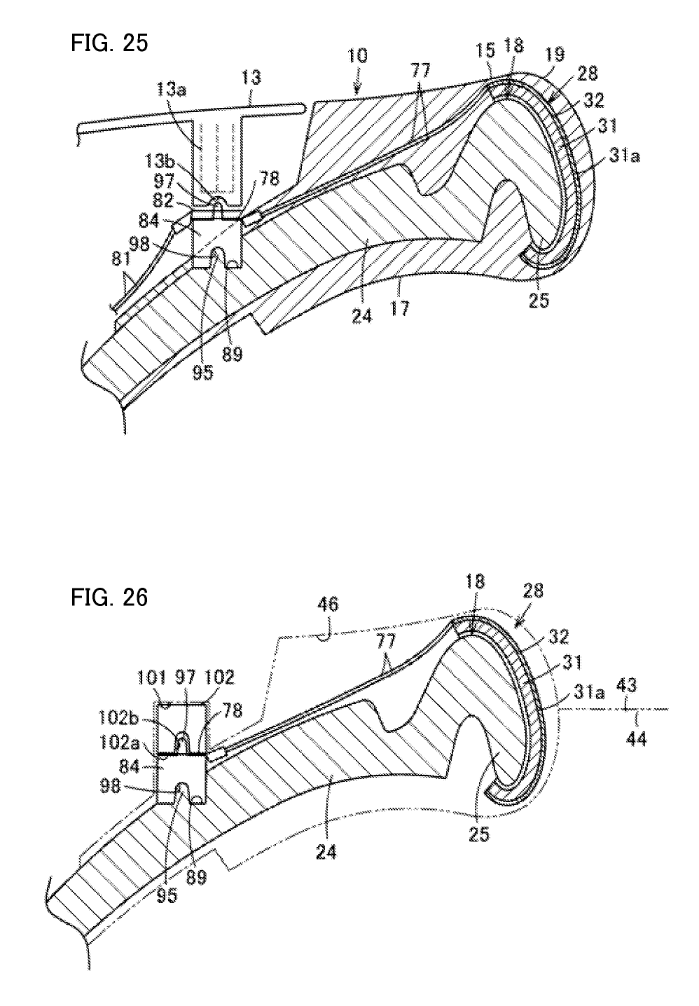

Subsequently, airbag unit 12 and finisher 13 are attached to complete steering wheel 10 (FIG. 25). During this process, finisher 13 encloses fixing member 84 by retainer rib 13a and holds fixing member 84 by fitting holding protruding portion 97 to fitting recess portion 13b. Moreover, finisher 13 pushes connection terminals 78 and 82, and retains electrical connection while preventing connection terminals 78 and 82 from turning and thus shifting in position.

As described above, according to the fourth embodiment, fixing member 84, which holds heater-side connection terminal 78 and vehicle-side connection terminal 82 so as to electrically connect heater 28 and the controller circuit, is configured to be held by fixing portion 89, which is provided in spoke cored bar 24. In addition, core metal 18 in a state where heater-side connection terminal 78 is held using fixing member 84 is inserted together with heater 28 into cavity 46 to mold cover portion 19. Thus, the fourth embodiment includes the same configuration as the third embodiment and brings about the same operational effects as the third embodiment.

In addition, fixing member 84 is configured not to be divided in this embodiment. Thus, it is possible to more simplify the configuration. Meanwhile, since the process of dividing fixing member 84 and reattaching fixing member 84 is no longer required, the manufacturing performance can be further improved.

### Fifth Embodiment

Note that, bearing recess portion 101 may be provided in first mold surface 43a of first half mold 43 of shaping mold 41 in the fourth embodiment mentioned above, as in a fifth embodiment illustrated in FIG. 25. In addition, protection member 102 for protecting fixing member 84 and heater-side connection terminal 78 which have been inserted into cavity 46 may be attached to bearing recess portion 101.

More specifically, protection member 102 includes: planar close-contact surface 102a, which is in close contact with heater-side connection terminal 78 without any gap in a state where shaping mold 41 is closed; and protection recess portion 102b, which is provided in close-contact surface 102a as a recess, and which forms male-female connection with holding protruding portion 97. In this configuration, protection member 102 is formed using a soft material such as silicone rubber. Thus, heater-side connection terminal 78 is held between soft fixing member 84 and protection member 102, so that damage to heater-side connection terminal 78 during molding can be more surely prevented. Note that, protection member 102 may be replaced each predetermined cycle (several hundred cycles) of molding, for example, or when damage occurs.

In each of the fourth and the fifth embodiments, fixing member 84 may be in a rectangular parallelepiped or polygonal columnar shape instead of columnar shape, for example. With this configuration, fixing member 84 can be prevented from turning while fitted to fixing portion 89, so that connection terminals 78 and 82 can be more surely prevented from turning and thus shifting in position. In this configuration, it is preferable to match the shape of connection terminals 78 and 82 with a cross-sectional shape of fixing member 84 rather than an annular shape.

Moreover, in case of adopting a design in which finisher 13 is integrally formed with the airbag cover of airbag unit 12, for example, a spring as a separate element may be used as a biasing member, instead of retainer rib 13a. In this manner, a contact point can be brought into contact without blocking the operation of a horn switch mechanism integrally incorporated into airbag unit 12.

Moreover, heater 28 (porous sheet 31) is formed annularly, first, and then wound around rim core metal 25 in each of the embodiments, but heater 28 (porous sheet 31) does not have to be formed annularly. For example, one end of heater 28 may be fixed by winding the one end around rim core metal 25, and the other end is pulled while applying tension and fixed to rim core metal 25 by winding the other end around rim core metal 25. The intermediate portion between these two ends is then fixed by winding the intermediate portion around rim core metal 25, for example.

In addition, steering wheel 10 is not limited to the configuration including three spoke portions 17, and may be applied to a configuration including at least two spoke portions on both lateral sides.

Moreover, a pad body that houses a shock absorber, for example, may be used instead of airbag unit 12.

### INDUSTRIAL APPLICABILITY

The present invention is favorably used for a steering wheel of an automobile, for example.

### REFERENCE SIGNS LIST

10 Steering wheel serving as a steering
15 Rim portion serving as a grip portion
19 Cover portion
25 Rim core metal serving as a grip-part core metal
28 Heater
31 Porous sheet
31a Front Surface
32 Heating wire
34 Synthetic resin material
41 Shaping mold
46 Cavity

1. A steering comprising an operational grip portion, wherein
the operational grip portion includes:
a grip-part core metal,
a cover portion that is made of a synthetic resin and that covers the grip-part core metal, and
a heater embedded in the cover portion, wherein
the heater includes:
a porous sheet having a density equal to 30±5 kg/m³ and a number of cells equal to 8±2 cells/25 mm, the porous sheet being wound around the grip-part core metal and embedded in the grip portion, and
a heating wire fixed to a surface of the porous sheet, embedded in the cover portion, and configured to generate heat by energization.

2. The steering according to claim 1, wherein the heater is embedded at a depth equal to or greater than 0.5 mm from a surface of the cover portion.

3. A method of manufacturing a steering including an operational grip portion which includes: a grip-part core metal, a cover portion that is made of a synthetic resin and that covers the grip-part core metal, and a heater embedded in the cover portion, the method comprising:
using a heater in which a heating wire is fixed to a porous sheet having a density equal to 30±5 kg/m³ and a number of cells equal to 8±2 cells/25 mm, and which serves as the heater to be embedded in the cover portion;
opening a shaping mold, winding the heater around the grip-part core metal, and setting the wound heater in a cavity; and
closing the shaping mold and injecting a synthetic resin material into the cavity to mold the cover portion by integrally covering the grip-part core metal and the heater with the synthetic resin.

4. The method of manufacturing a steering according to claim 3, wherein the heater is wound around the grip-part core metal with the heating wire placed at an outer side position.
